(19) United States
(12) Patent Application Publication
(10) Pub. No.: US 2009/0049721 A1
(43) Pub. Date: Feb. 26, 2009

(54) Decorative design magnets

(76) Inventor: Caren E. Katz, Commack, NY (US)

Correspondence Address: SCULLY SCOTT MURPHY & PRESSER, PC, 400 GARDEN CITY PLAZA, SUITE 300, GARDEN CITY, NY, 11530, US

(21) Appl. No.: 11/894,138

(22) Filed: Aug. 20, 2007

(51) Int. Cl. G09F 7/04

(52) U.S. Cl. 40/600; 40/591

(57) ABSTRACT

A decorative apparatus includes a plurality of structures in specified shapes. A magnetic element is coupled to a bottom surface of each of the plurality of structures for removable magnetic attachment to a metal surface. A plurality of decorative elements are coupled to a top surface of each of the plurality of structures, and the plurality of decorative elements are arranged in a pattern. The plurality of structures may include a magnetic sheet having a magnetic bottom surface, and a decorative top surface which may include vinyl.

### BACKGROUND OF THE INVENTION

1. Field of the Invention

The present invention relates to ornamental devices, and more particularly, magnetic ornamental devices for attachment to a metal surface.

2. Description of the Related Art

Known in the art are decorative and functional structures or objects using removable magnetic devices, for example, magnet strips or magnetic sheeting for attachment to a metal such as a vehicle or on an appliance in the home. Devices may be of specific shapes and designs and may also be made for use on specific types of surfaces (e.g., appliances or automobiles). Further, magnetic devices or signs can provide information, such as an advertisement, a temporary license plate, or indication of an emergency vehicle, etc.

For example, magnetic signs affixed to the side of a vehicle may provide company information and/or advertisement. Other examples include decorative devices of fixed designs or pictures which may be created for specific locations on a vehicle, or provides a means to hold other items onto a vehicle. In another example, magnetic ornaments in the home or office may have specific shapes, or sizes for decorative use on various appliances and other metallic surfaces. However, known decorative and functional objects are limited to specifically designed decorations, symbols, or signs. A further drawback of known devices includes the inability to create an aesthetically pleasing design using magnetic devices.

Therefore, it would be desirable to provide a magnetic device which can be easily removable, inexpensive, and aesthetic pleasing to a person or user. It would further be desirable for a magnetic device to provide a person the ability to customize a design or picture to their own aesthetic taste.

### SUMMARY OF THE INVENTION

In an aspect of the invention, a decorative apparatus includes a plurality of decorative structures in specified shapes. A bottom surface of the decorative structures each include a magnetic portion for removably attaching to a metal surface. A top surface of the decorative structures each include a decorative portion for display and for being arranged in an arbitrary pattern by a user.

In a related aspect, the structures further include a plurality of magnetic elements coupled to the bottom surface of each of the plurality of structures.

In a related aspect, the structures further include a plurality of decorative elements coupled to the top surface of each of the plurality of structures.

In a related aspect, the decorative elements include vinyl. In a related aspect, the metal surface is part of a vehicle.

In a related aspect, the plurality of structures are removable attached to the metal surface of a vehicle using the magnetic elements.

In a related aspect, the decorative elements fit together in a pattern.

In a related aspect, a user fits the decorative elements together in a pattern.

In a related aspect, the plurality of decorative structures fit together with the decorative portions depicting a prearranged design or picture.

In a related aspect, the plurality of decorative structures fit in spaced relation to each other and the decorative portions depict a prearranged design or picture.

In a related aspect, the decorative portions include one or more colors.

In a related aspect, the decorative portions are weather resistant.

In a related aspect, the decorative portions include vinyl.

In another aspect of the invention, a method of decorating a metal surface includes providing a plurality of decorative elements in specified shapes, where the decorative elements have a bottom surface including a magnetic portion; decorating at least a portion of a top surface of the decorative elements; and positioning at least part of the plurality of decorative elements in a pattern on a metal surface.

In a related aspect, the pattern is specified by a user.

In a related aspect, the method further includes positioning the plurality of decorative elements in a specified pattern depicting a picture.

In another aspect of the invention a decorative design kit includes a plurality of decorative devices in specified shapes. A bottom surface of the decorative devices includes a magnetic portion for removably attaching to a metal surface. A top surface of the decorative devices includes a decorative portion for display and for decorating a metal surface in a pattern.

In a related aspect, the kit further includes at least one sample pattern for the decorative devices.

### BRIEF DESCRIPTION OF THE DRAWINGS

These and other objects, features and advantages of the present invention will become apparent from the following detailed description of illustrative embodiments thereof, which is to be read in connection with the accompanying drawings, in which:

FIG. 1 is a plan view of decorative apparatuses according to an embodiment of the invention depicting a plurality of randomly shaped decorative magnets;

FIG. 2 is a side elevational view of a decorative magnet shown in FIG. 1 depicting a decorative element and a magnetic element;

FIG. 3 is a side elevational view of an alternative embodiment of a decorative magnet depicting a center element between the decorative element and the magnetic element;

FIG. 4 is a perspective side elevational view of the decorative magnets shown in FIG. 1 in an embodiment of a design on a rear quarter panel of a car; and

FIG. 5 is a rear elevational view of the decorative magnets shown in FIG. 1 in another embodiment of a design on a trunk of a car.

### DETAILED DESCRIPTION OF THE INVENTION

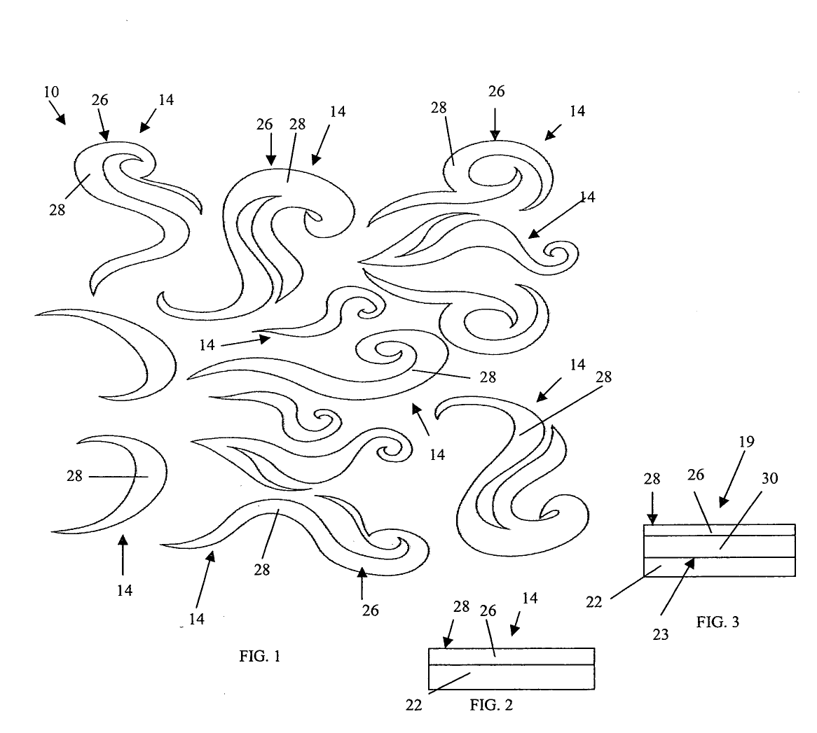

An illustrative embodiment according to the present invention of a decorative apparatus 10 including decorative structures or devices 14, shown in FIG. 1. The plurality of decorative devices 14 are in a variety of specified shapes. The decorative devices 14 can, for example, have any combination of curved and/or straight edges. The decorative devices 14 can be positioned in a pattern as designated by a user, for example, an arbitrary pattern, a picture or design or a variation of a picture or design intended by the user. Since the devices 14 are removable and reusable, the pattern can be changed or re-arranged as many times, and in as many variations as the user wishes.

Referring to FIG. 2, each of the decorative devices 14 includes a magnetic element 22. The magnetic element 22, may be magnetic sheeting, and is of sufficient thickness (e.g., 30 mm or greater) to provide adequate adhesion to the surface of a moving vehicle so that the magnet will stay affixed to a car moving at about 75 miles per hour.

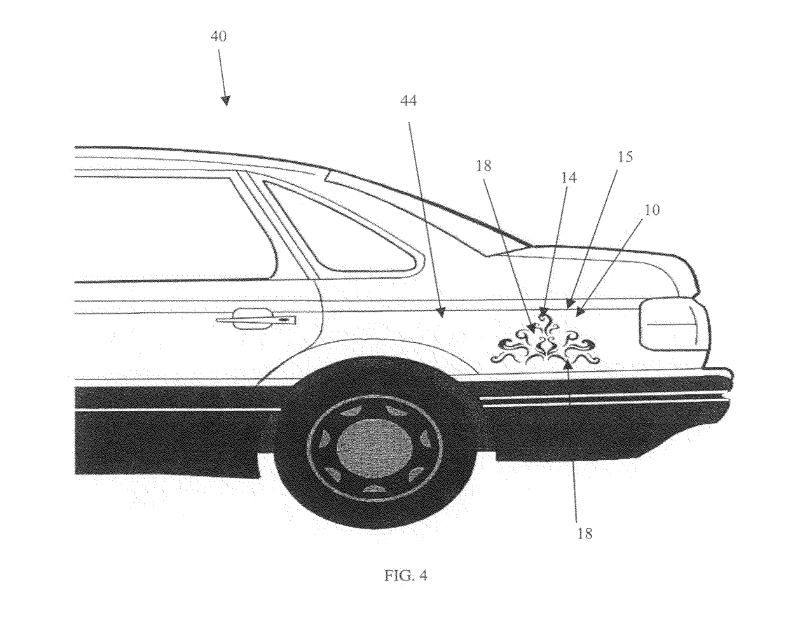

Alternatively, as shown in FIG. 3, in another embodiment, a decorative device 19 includes the magnetic element 22, for example, glued or adhered to at least a portion of a bottom surface or covering the entire bottom surface of a center element 30. Thus, the magnetic element 22 shown in FIGS. 2 and 3, has a magnetic bottom surface 23 which magnetically affixes to any metal surface. The strength of the magnetic element 22, and thereby the ability of the magnet bottom surface 23 to adhere to a metal surface, is designed to fixedly remain on a moving vehicle at least to the speed of about 75 miles per hour.

A decorative element 26 is coupled to the magnetic element 22 as shown in FIG. 2, or alternatively, coupled to a top surface of the center element 30 as shown in FIG. 3 and in the same or alternative manner as the magnetic element 22. The decorative element 26 may be made of vinyl and adhered to the center structure 30, or in an alternative embodiment, adhered directly to the magnetic element 22. The decorative element 26 includes a top surface 28 having a decorative design, or color or combination thereof. The top surface of the sheeting is generally vinyl to which a graphic design (using a solid-color magnetic sheet, ink printing and photography are some examples) is affixed. The images may be figural or abstract. Alternate manufacturing techniques might also allow for the printing of a design on paper prior to being laminated to a vinyl top surface of the element 26 or directly to a top surface of the magnetic element 22 or a magnetic sheet. Another alternative embodiment may include an additional layer affixed over the top surface 28 of the element 26, or affixed directly to magnetic sheeting embodied as the magnetic element 22 which includes a raised or protruding design.

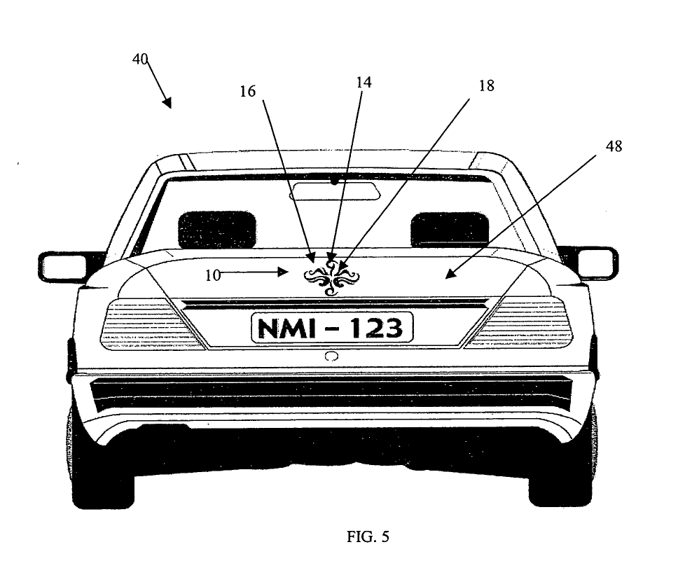

The top surface 28 of the decorative element 26 may depict a portion of a larger picture, so when combined with other decorative elements 26 a desired picture is formed. Also, the top surface 28 of the decorative elements 26 may include specific colors or combinations of colors, or alternatively, textures of materials may be used as well. At least the top surface 28 of the decorative element 26 is weather resistant so that it can be used outside in many types of weather and in the sun without losing its decorative appeal. Weather resistance can take the form of a weather resistant substance used to make the decorative element 26, a protective film, a covering over the decorative element 26, or an eco-solvent ink. The magnetic element 22 enables the decorative device 14 to be magnetically attached to a metal surface and removable from a metal surface on, for example, a vehicle as shown in FIGS. 4 and 5. Further, the magnetic element 22 is designed to not damage a car's finish with proper care.

Referring to FIGS. 4 and 5 the decorative devices 14 may be magnetically attached to a vehicle 40 in any arbitrary pattern using as many of the devices 14 as the user desires. The pattern 15 of the decorative devices 14 shown in FIG. 4 is an example of one such pattern on the driver's side rear quarter panel 44 of a vehicle 40. Another pattern 16 of the decorative devices 14 is shown in FIG. 5 on the rear facing portion of the trunk 48. The patterns 15, 16 include decorative devices 14 having spaces 18 therebetween. The arrangement of the devices 14 and spacing 18 is completely at the discretion of the user. The devices 14 may also be adapted to fit together to depict a picture. Alternatively, the devices 14 may fit together to form a picture and be in spaced relation to each other as the user desires.

In use, a user positions decorative devices 14 on a metal surface such as a vehicle to create a desired pattern. The removable magnetic decorative devices 14 may be moved and rearranged at will and put in various positions.

The decorative devices 14 may be included in a kit providing a plurality of decorative devices and pictures of possible patterns. The kit provides the necessary pieces, pre-cut and pre-fit and forming a desired picture when fitted together properly by the user. The kit, according to the present invention, may include decorative devices having different angles, designs and lettering for abstract configuration, as well as, be pieces of a picture that may be used in part by the user.

The decorative design apparatus according to the present invention thereby provides decorative devices 14 which are economical to produce and use. The decorative devices 14 are easily removable, pre-cut components which can be used individually or in combination to provide unique designs by simply arranging and re-arranging the components on a vehicle or other metal surface. Further, in an alternative embodiment, the invention includes die-cut magnetic sheeting providing pre-cut components that can be used alone or in combination to provide designs that are novel, personalized and aesthetically pleasing to the individual positioning them.

The top surface 28 of the decorative element 26 may be a single color or have designs applied utilizing screen printing, photography, stenciling or the like. The decorative devices 14 may be used on any metal surface which includes the doors, fender, trunk, etc. of a vehicle, as well as, file cabinets, doors, appliances, etc.

Thus, the present invention allows an individual to personalize their vehicle or surroundings to better represent their creative nature or style. The number of decorative elements 14 used from the decorative apparatus 10, final size and configurations are each determined by the user, thus allowing for a near limitless number of individualized abstract and non-abstract designs to be created.

In an alternative embodiment, the decorative devices 14 may be cut from a sheet of magnetic material such that the bottom surface is inherently magnetic. The top surface is decorated using a weather resistant paint or ink on at least a portion of the top surface. Similarly, a magnetic material can be designed to not damage a car's finish with proper care.

While the present invention has been particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

1. A decorative apparatus, comprising:
a plurality of decorative structures in various shapes;
a bottom surface of the decorative structures each including a magnetic portion having a specified magnetic strength for removably attaching to a metal surface being part of a vehicle, and the metal surface being at an angle from a horizontal plane; and
a top surface of the decorative structures each including a decorative portion for display and for being arranged in an arbitrary pattern by a user, the plurality of structures being removable attached to the metal surface of the vehicle using the magnetic portions, and the magnetic portions remain attached to the vehicle's metal surface when the vehicle travels at a specified speed.

2. The apparatus of claim 1, wherein the magnetic portion includes a magnetic element coupled to the bottom surface of each of the plurality of structures.

3. The apparatus of claim 1, wherein the decorative portion includes a decorative element coupled to the top surface of each of the plurality of structures.

4. The apparatus of claim 3, wherein the decorative elements include vinyl.

5. (canceled)

6. (canceled)

7. The apparatus of claim 21, wherein the magnetic portions remain attached to the vehicles metal surface when the vehicle reaches a speed of about 75 miles per hour.

8. The apparatus of claim 1, wherein the decorative portions fit together in the arbitrary pattern.

9. The apparatus of claim 1, wherein a user fits the decorative portions together in the arbitrary pattern.

10. The apparatus of claim 1, wherein the plurality of decorative structures fit together with the decorative portions depicting a prearranged design or picture.

11. The apparatus of claim 1, wherein the plurality of decorative structures fit in spaced relation to each other and the decorative portion depicts a prearranged design or picture.

12. The apparatus of claim 1, wherein the decorative portions are weather resistant.

13. The apparatus of claim 1, wherein the decorative portions include one or more colors.

14. The apparatus of claim 1, wherein the decorative portions include vinyl.

15. A method of decorating a metal surface, comprising:
providing a plurality of decorative elements in specified shapes, the decorative elements having a bottom surface including a magnetic portion having a specified magnetic strength;
decorating at least a portion of a top surface of the decorative elements; and
positioning at least part of the plurality of decorative elements in an arbitrary pattern on a metal surface being part of a vehicle, and the metal surface being at an angle from a horizontal plane the plurality of structures being removable attached to the metal surface of the vehicle using the magnetic portions, and the magnetic portions remaining attached to the vehicle's metal surface when the vehicle travels at a specified speed.

16. The method of claim 15, wherein the pattern is specified by a user.

17. The method of claim 15, further including positioning the plurality of decorative elements in a specified pattern depicting a picture.

18. A decorative design kit, comprising:
a plurality of decorative devices in specified shapes;
a bottom surface of the decorative devices including a magnetic portion having a specified magnetic strength for removably attaching to a metal surface being part of a vehicle, and the metal surface being at an angle from a horizontal plane; and
a top surface of the decorative devices includes a decorative portion for display and for decorating a metal surface in an arbitrary pattern, the plurality of structures being removable attachable to the metal surface of the vehicle using the magnetic portions, and the magnetic portions remain attached to the vehicle's metal surface when the vehicle travels at a specified speed.

19. (canceled)

20. The apparatus of claim 1, wherein the decorative structures are applied to a substantially vertical metal surface of the vehicle.

21. The apparatus of claim 1, wherein the decorative structures are a specified thickness to provide the specified magnetic strength for attachment to the metal surface when the vehicle travels at the specified speed.
